(19) United States
(12) Patent Application Publication
(10) Pub. No.: US 2013/0075400 A1
(43) Pub. Date: Mar. 28, 2013

(54) PEDAL-OPERATED CART

(71) Applicant: Rehrig Pacific Company, Los Angeles, CA (US)

(72) Inventors: William Robinson, Los Angeles, CA (US); Margaret McCanless, El Segundo, CA (US)

(73) Assignee: Rehrig Pacific Company, Los Angeles, CA (US)

(21) Appl. No.: 13/626,998

(22) Filed: Sep. 26, 2012

Related U.S. Application Data
(60) Provisional application No. 61/538,939, filed on Sep. 26, 2011.
(60) Provisional application No. 61/669,195, filed on Jul. 9, 2012.

(51) Int. Cl. B65D 43/26; A47B 55/00; B65F 1/14; B62B 5/00

(52) U.S. Cl. 220/263; 280/47.34; 211/71.01

(57) ABSTRACT

A cart according includes a frame for supporting a container. A pedal is connected to the frame. An arm for opening a lid of the container is supported by the frame. Linkage connects the arm to the pedal, so that when the pedal is depressed, the arm lifts open the lid of the container. Existing container designs can be used with the cart. The pedal and arm can be used to lift open the lid of the existing container. The existing containers can easily be removed and replaced on the cart.

### BACKGROUND

The present invention relates to hands-free mechanisms for opening lids of containers.

Containers with hinged lids are often used for waste, such as medical waste. It is sometimes undesirable to touch the lid to open it, either because the user's hands are occupied or in order to avoid contamination. There are containers with attached pedals for operating the lid hands-free, but the pedals are permanently attached to the containers. The pedals cannot be removed from the cart and the pedals cannot be used with existing containers. This limits the use of the existing pedal designs.

### SUMMARY

A cart according to one embodiment of the present invention includes a frame for supporting a container. A pedal is connected to the frame. An arm for opening a lid of the container is supported by the frame. Linkage connects the arm to the pedal, so that when the pedal is depressed, the arm lifts open the lid of the container.

In the disclosed embodiments, existing container designs can be used with the cart. The pedal and arm can be used to lift open the lid of the existing container. The existing containers can easily be removed and replaced on the cart.

### BRIEF DESCRIPTION OF THE DRAWINGS

FIG. 1 is a perspective view of a cart according to one embodiment of the present invention with a container supported thereon.

FIG. 2 shows the cart and container of FIG. 1 with the pedal depressed and the arm lifting open the lid.

FIG. 3 is a front view of the cart of FIG. 1.

FIG. 4 is a perspective view of the cart of FIG. 1.

FIG. 5 is a side view of the cart of FIG. 1.

FIG. 6 is a perspective view of the cart of FIG. 1 with the pedal depressed and the arm lifted.

FIG. 7 is a side view of the cart of FIG. 6.

FIG. 8 is a perspective view of the cart and container of FIG. 1 showing a step in connecting the lid to the arm.

FIG. 9 shows a step subsequent to FIG. 8 of connecting the lid to the arm.

FIG. 10 is an enlarged perspective view of the lower portion of the cart and container of FIG. 1.

FIG. 11 is a side view of the cart and container of FIG. 10.

FIG. 12 is a section view through the upper portion of the cart and container of FIG. 1.

FIG. 13 is a section view through the coupling of FIG. 12.

FIG. 14 is a bottom perspective view of the cart and container of FIG. 1 with the pedal depressed and the arm lifting the lid.

FIG. 15 is an upper perspective view of the cart and container of FIG. 14.

FIG. 16 is a perspective view of a cart according to a second embodiment.

FIG. 17 is an exploded perspective view of the cart of FIG. 16.

FIG. 18 is an enlarged view of the upper end of the cart of FIG. 17.

FIG. 19 shows the cart of FIG. 16 with a container installed thereon.

FIG. 20 shows the cart and container of FIG. 19 with the pedal depressed and the arm lifting open the lid.

FIG. 21 is a front view of the cart and container of FIG. 19.

FIG. 22 is a section view taken along line 22-22 of FIG. 21.

FIG. 23 is an enlarged view of the connection between the arm and the lid.

FIG. 24 shows the installation of the container onto the cart

### DETAILED DESCRIPTION OF PREFERRED EMBODIMENTS

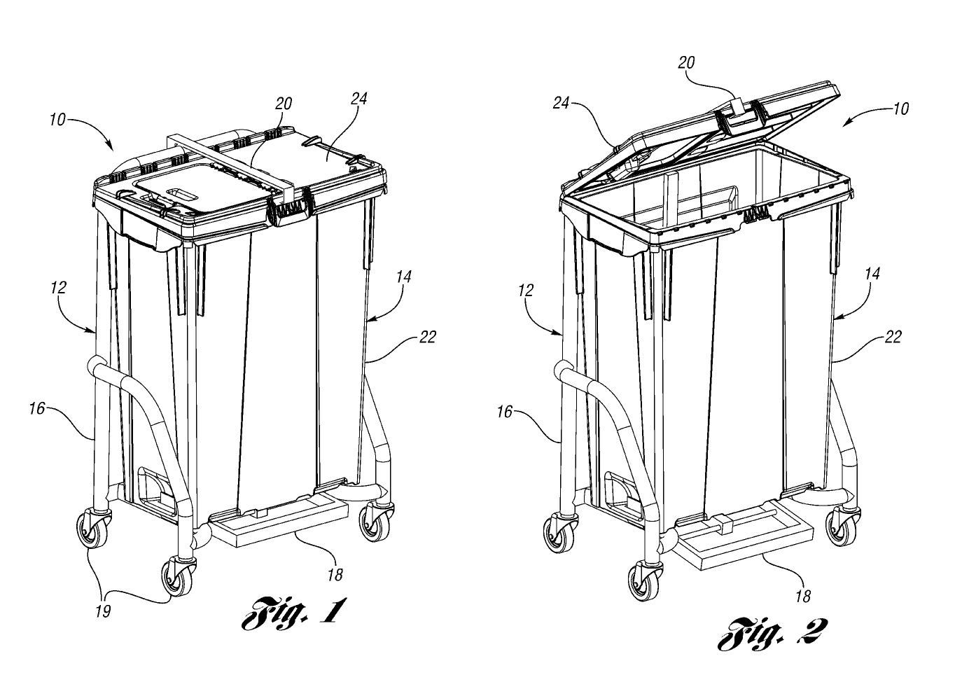

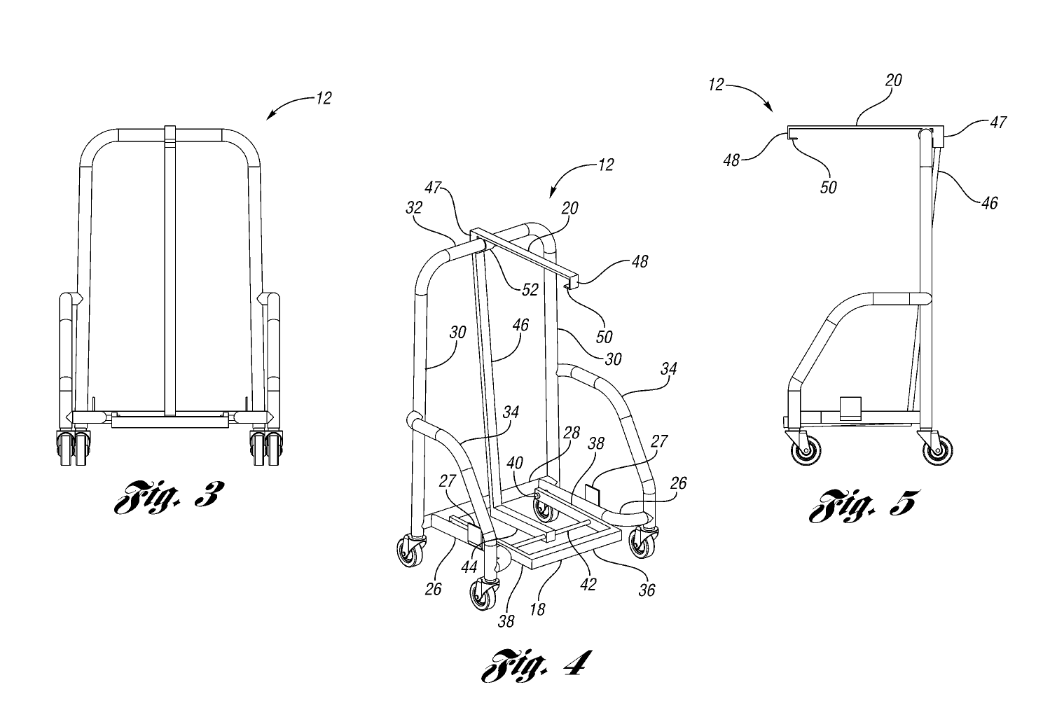

An assembly 10 of a pedal-operated cart 12 and container 14 is shown in FIG. 1. The cart 12 is an assembly including a frame 16 and a pedal 18 extending from the front of the frame 16. Optional casters 19 may extend downward from the frame 16 to provide pivotable wheels supporting the frame 16. An arm 20 extends from a top of the frame 16. The container 14 is an existing container design, i.e. it is not specially designed for use with the cart 12. The container 14 includes a body portion 22 and a lid 24 hingeably connected to the body portion 22. The arm 20 connects to a front of the lid 24. As shown in FIG. 2, when the pedal 18 is depressed, the arm 20 opens the lid 24 of the container 14. In this manner, waste can be placed in the container 14 by a user simply by pressing the pedal 18, without touching the lid 24. The cart 12 can be used with an existing container 14, which can be removed and replaced on the cart 12.

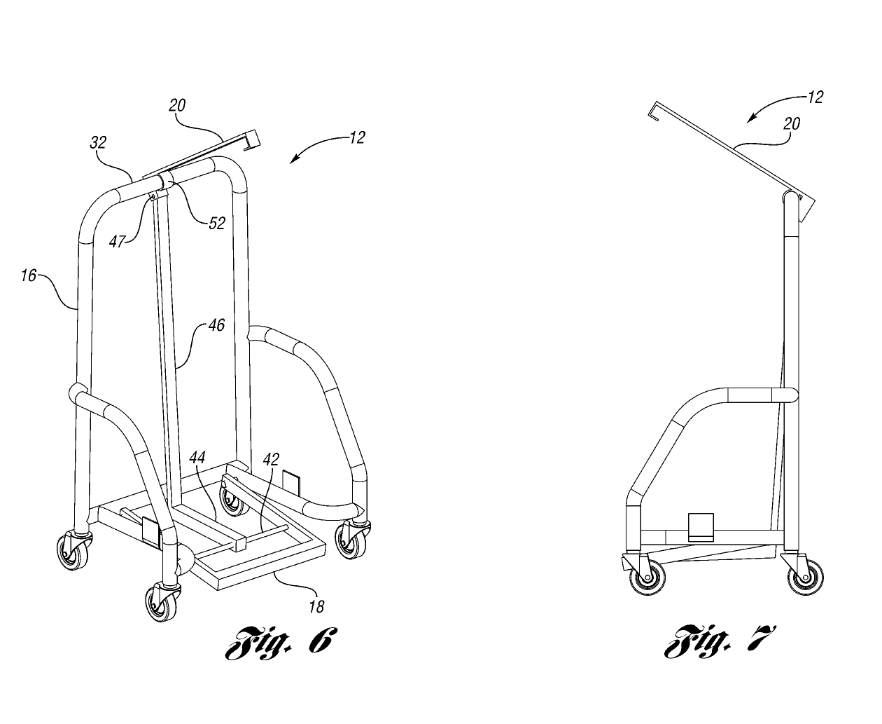

The cart 12 is shown in FIGS. 3-5. Referring to FIG. 4, the cart 12 is shown as an arrangement of connected metal tubing, but other materials and structures could be used. The cart 12 includes a base formed by side base sections 26 and a rear base section 28. A connector plate 27 extends upward from each of the side base sections 26. Rear upright sections 30 extend upward from outer ends of the rear base section 28 and connect to a rear cross-rail 32. Side rails 43 extend at an angle from a mid-portion of each rear upright section 30 to a forward end of each side base section 26.

The pedal 18 includes a front bar 36 connected by arms 38 to pivot points 40 at the rear of the side base sections 26. A pivot pin 42 connects to the arms 38 at a point spaced rearward from the front bar 36. A lower linkage 44 extends rearward from the pivot pin 42 to a generally vertical rear linkage 46. The rear linkage 46 pivotably connects to a rear flange 47 at a rear end of the arm 20. A forward portion of the arm includes a connector or hook formed by a downward projection 48 and a rearward projection 50. The rear flange 47 is connected by a rotatable coupling 52 to the rear cross-rail 32 of the frame 16.

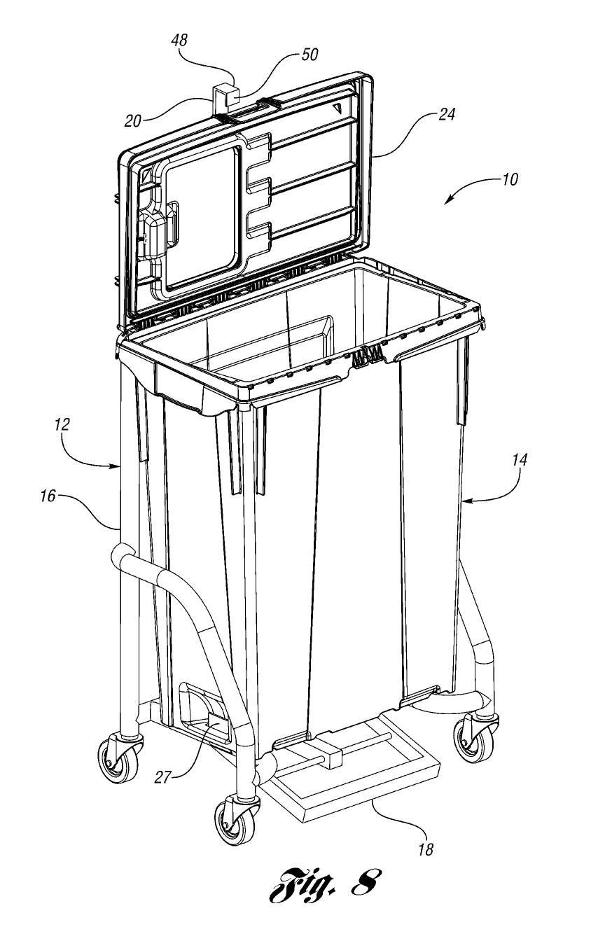

FIGS. 6-7 show the cart 12 with the pedal 18 depressed. As shown in FIG. 6, depressing the pedal 18 draws down the pivot pin 42 and the lower linkage 44. The rear linkage 46 in turn pulls down on the rear flange 47, which causes the rear flange 47 to rotate the coupling 52, thereby rotating the arm 20 upward.

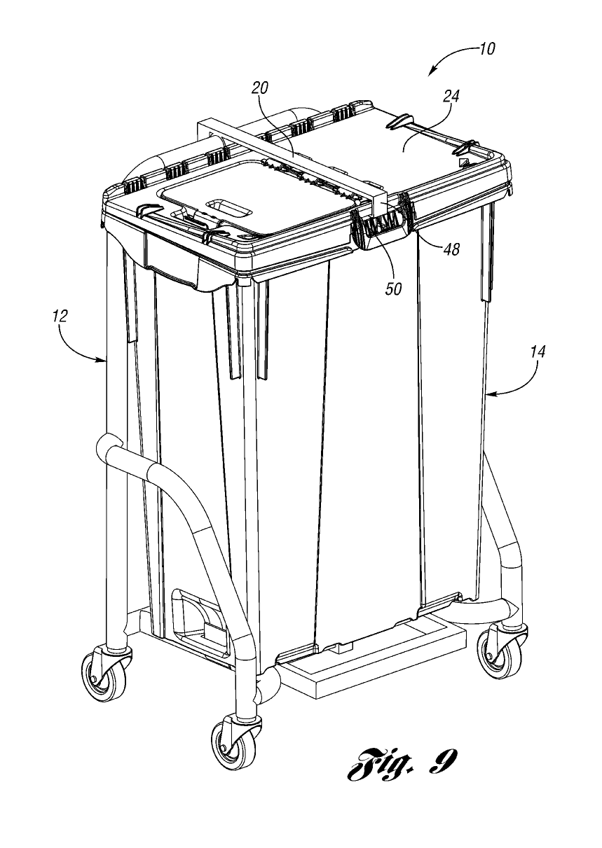

FIGS. 8-9 show the installation of the container 14 onto the cart 12. Referring to FIG. 8, after rotating the arm 20 upward and rearward, the container 14 is placed on the base of the cart 12. By opening the lid 24, the connector/hook portion of the arm 20 can be received in a recess or opening in the front of the lid 24 as the lid 24 is closed, as shown in FIG. 9. In this manner, the container 14 can be removed, emptied and/or replaced.

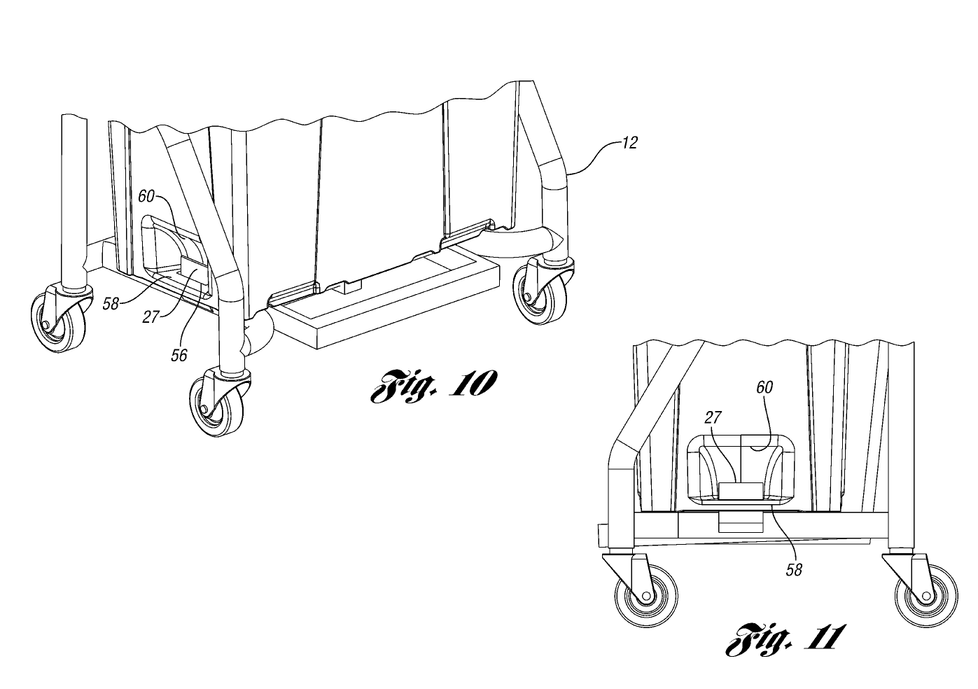

As shown in FIGS. 10 and 11, the connector plates 27 are received through openings 56 formed in flanges 58 adjacent recesses 60 in the container 14. This further stabilizes the container 14 on the cart 12.

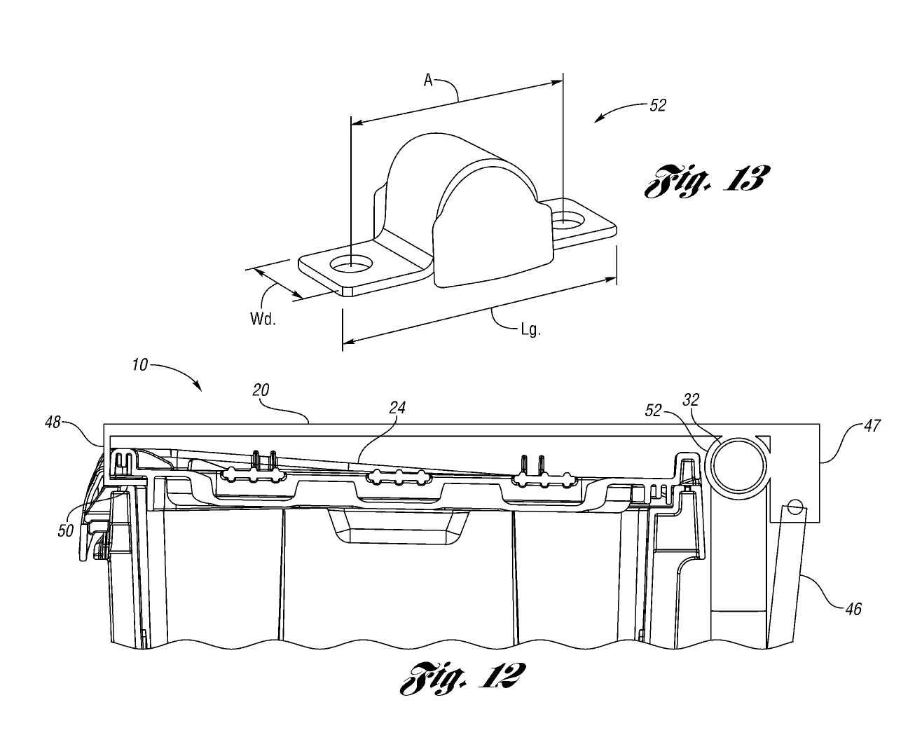

FIG. 12 is a section view through the lid 24 and arm 20. As shown, the connector/hook of the arm 20 (i.e. downward projection 48 and rearward projection 50) is received in a recess formed in the front of the lid 24. The arm 20 is pivotably secured to the rear cross-rail 32 of the frame 16 at a pivot axis just rearward of the pivot axis of the lid 24 by coupling 52. The rear linkage 46 is pivotably secured to the rear flange 47.

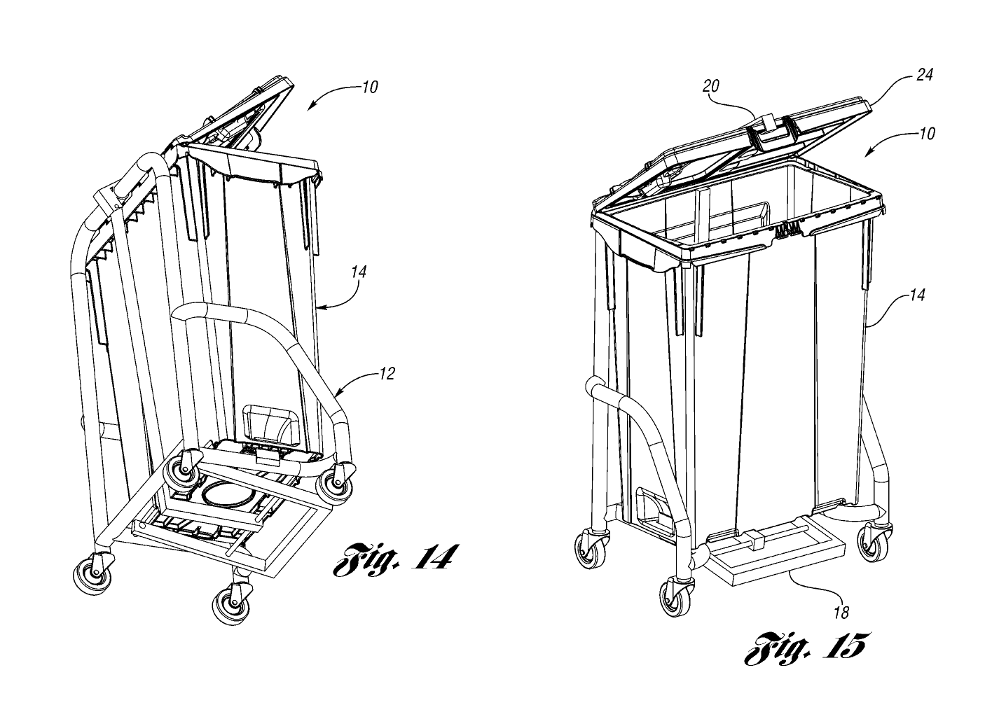

One example coupling 52 is shown in FIG. 13.

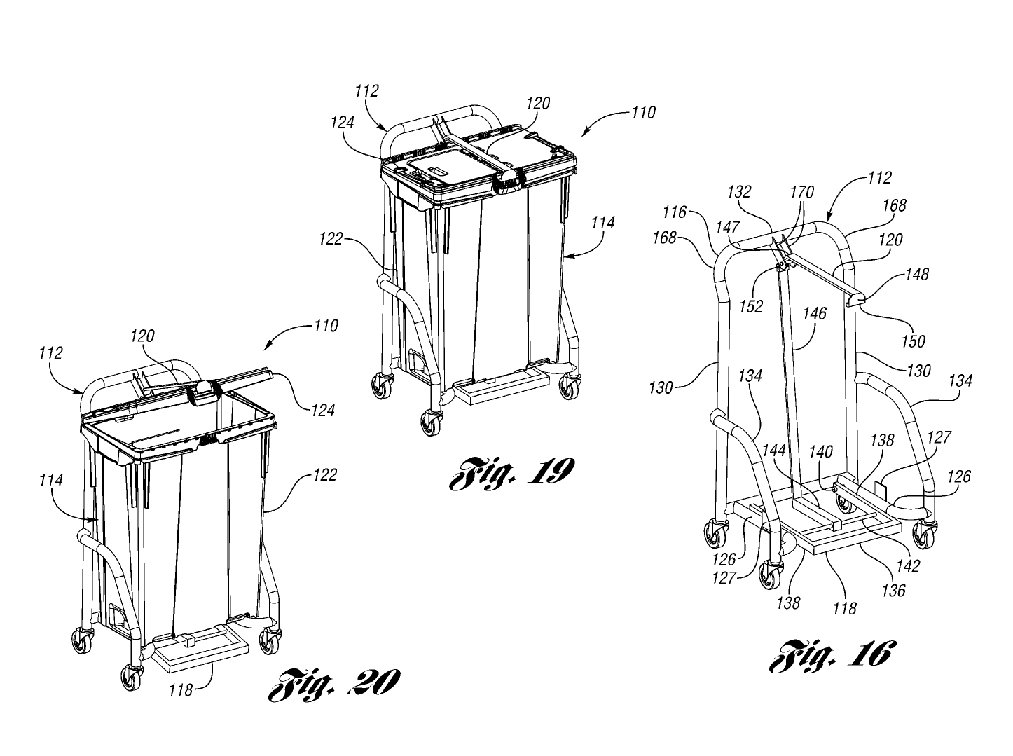

As shown in FIGS. 14-15, depressing the pedal 18, such as with the user's foot, opens the lid 24. In this manner, waste can be placed in the container 14 by a user simply by pressing the pedal 18, without touching the lid 24.

Another embodiment of a cart 112 is shown in FIG. 16. The cart 112 is shown as an arrangement of connected metal tubing, but other materials and structures could be used. The cart 112 includes a frame 116 and a pedal 118 extending from the front of the frame 116. An arm 120 extends from a top of the frame 116. The cart 112 includes a base formed by side base sections 126 and a rear base section 128. Optional casters support the frame 116. A connector plate 127 extends upward from each of the side base sections 126. Rear upright sections 130 extend upward from outer ends of the rear base section 128. Angled handle portions 168 extend upward and rearward from upper ends of the rear upright sections 130 and connect to a rear cross-rail 132, which functions as a handle for pulling the cart 112. Side rails 134 extend at an angle from a mid-portion of each rear upright section 130 to a forward end of each side base section 126.

A pedal 118 includes a front bar 136 connected by arms 138 to pivot points 140 at the rear of the side base sections 126. A pivot pin 142 connects to the arms 138 at a point spaced rearward from the front bar 136. A lower linkage 144 extends rearward from the pivot pin 142 to a generally vertical rear linkage 146. The rear linkage 146 pivotably connects to a rear flange 147 at a rear end of the arm 120. A forward portion of the arm includes a connector or hook formed by a downward projection 148 and a rearward projection 150. A pair of brackets 170 extend downward and forward from the rear cross-rail 132 to a pivot pin 152. The rear flange 147 is connected by the pivot pin 152 to the frame 116.

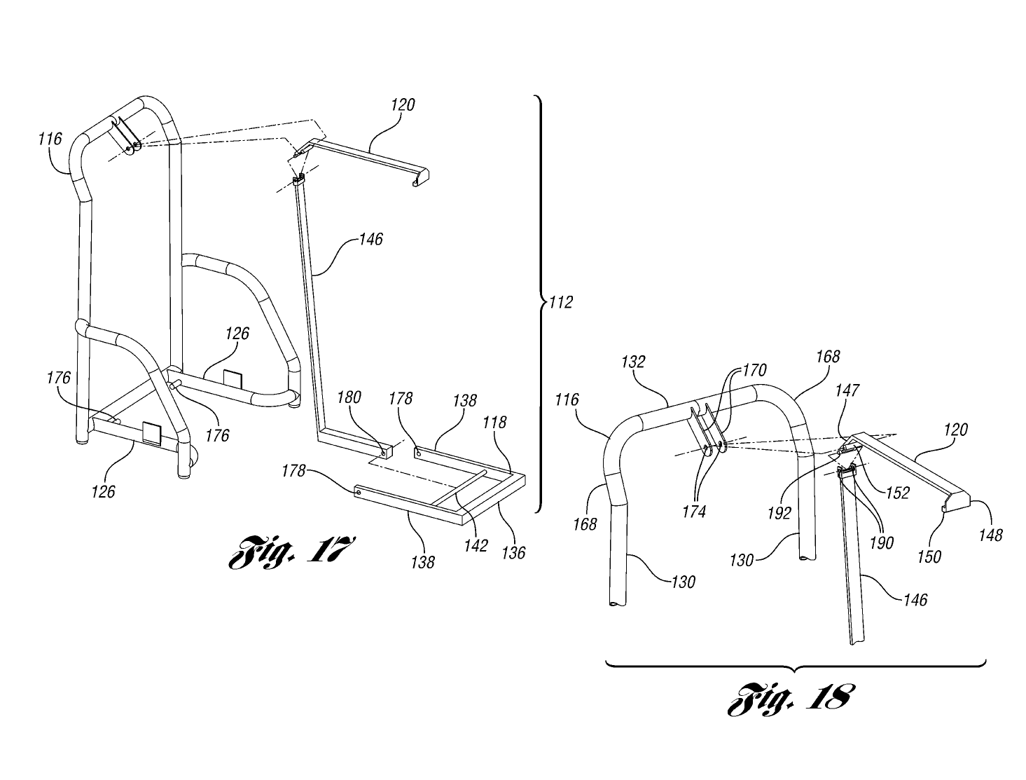

An exploded view of the cart 112 is shown in FIG. 17. Pivot pins 176 project inward from side base sections 126 and are complementary to apertures 178 formed at rear ends of the arms 138 of the pedal 118. An aperture 180 is formed through a forward end of the lower linkage 144 and is complementary to the pivot pin 142.

FIG. 18 is an enlarged exploded view of the upper end of the cart 112 of FIG. 17. Apertures 174 are formed at lower ends of the brackets 170 extending downward from the rear cross-rail 132 and are complementary to a pivot pin 152 secured to a mid-region of the rear flange 147 on the arm 120. Apertures 190 at the upper end of the rear linkage 146 are complementary to a pivot pin 192 formed at a lower end of the rear flange 147 of the arm 120. Obviously, in any of the pivot connections described herein, the pivot pins and apertures could be switched, and other pivot/hinge connections could be used.

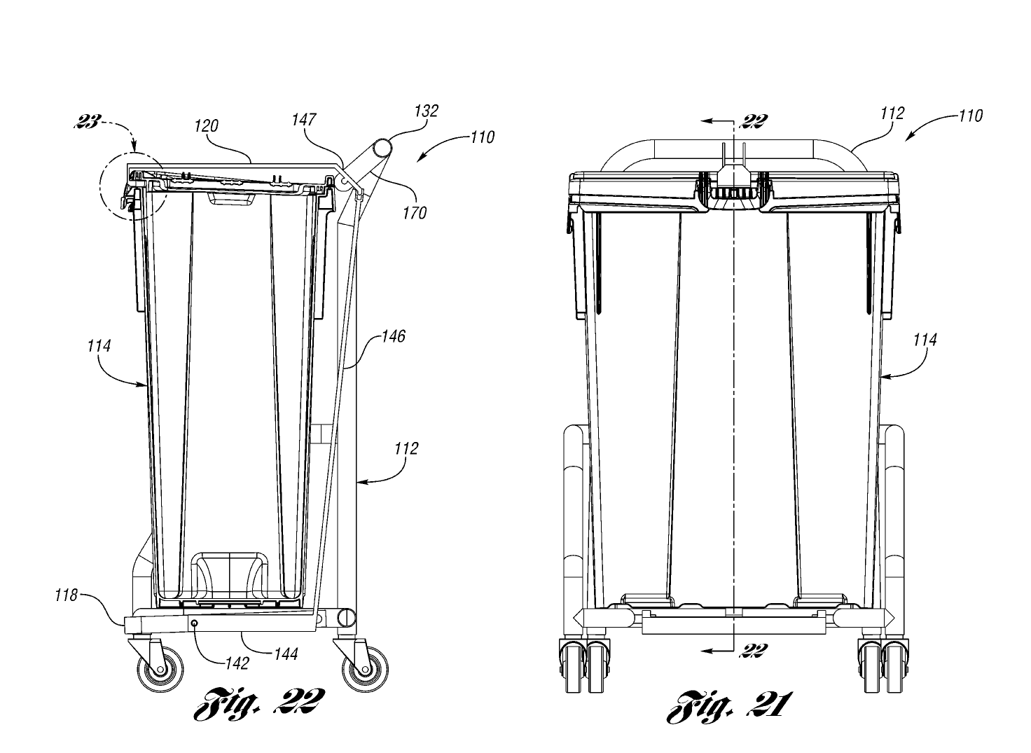

An assembly 110 of the pedal-operated cart 112 and a container 114 is shown in FIG. 19. The container 114 includes a body portion 122 and a lid 124 hingeably connected to the body portion 122. The arm 120 of the cart 112 connects to a front of the lid 124. As shown in FIG. 20, when the pedal 118 is depressed, the arm 120 opens the lid 124 of the container 114. In this manner, waste can be placed in the container 114 by a user simply by pressing the pedal 118, without touching the lid 124. The cart 112 can be used with an existing container 114 (i.e. the container 114 does not have to be specially adapted for use with the cart 112), which can be removed and replaced on the cart 112.

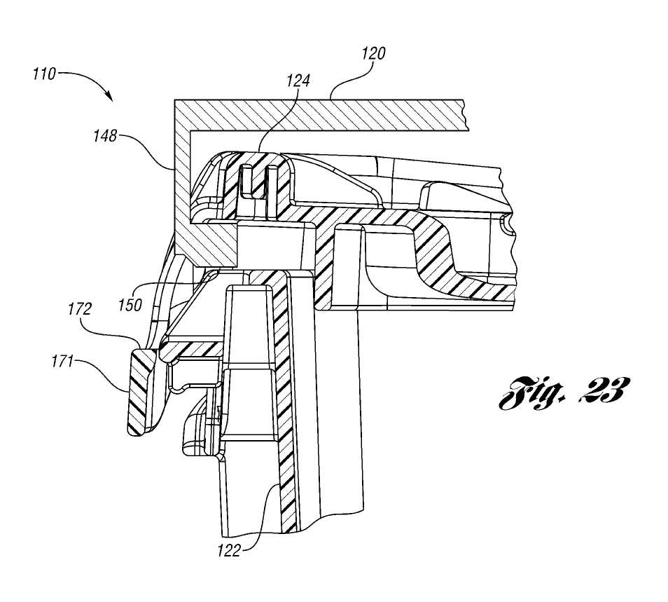

FIG. 21 is a front view of the cart 112 and container 114. FIG. 22 is a section view taken along line 22-22 of FIG. 21. Referring to FIG. 22, depressing the pedal 118 draws down the pivot pin 142 and the lower linkage 144. The rear linkage 146 in turn pulls down on the rear flange 147, which causes the rear flange 147 to pivot on the pivot pin 152, thereby rotating the arm 120 upward.

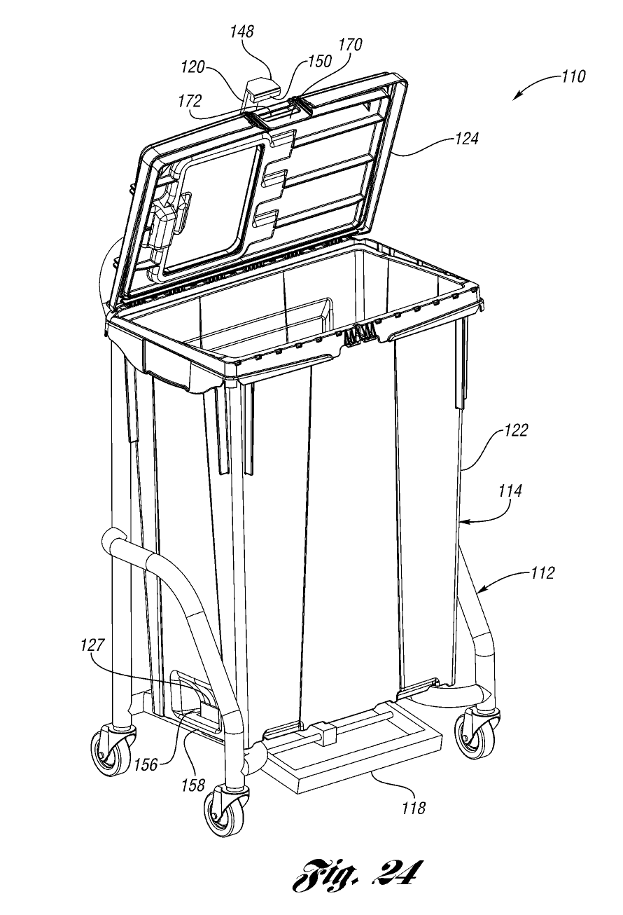

FIG. 23 is an enlarged view of the connection between the arm 120 and the lid 124. The front of the lid 124 includes a latch portion 171 having a latch opening 172 defined above the latch portion 171. The rearward projection 150 of the arm 120 extends into the opening 172 at the front of the lid 124. A downward protrusion from the lower surface of the rearward projection 150 increases the overall thickness of the rearward projection 150 to prevent the latch portion 171 from latching to the body portion 122 of the container 114.

FIG. 24 shows the installation of the container 114 onto the cart 112. After rotating the arm 120 upward and rearward, the container 114 is placed on the base of the cart 112. By opening the lid 124, the connector/hook portion of the arm 120 can be received in the latch opening 172 in the front of the lid 124 as the lid 124 is closed, as shown in FIG. 20. In this manner, the container 114 can be removed, emptied and/or replaced. The container 114 can be removed from the cart 112 by rotating the arm 120 back to the position shown in FIG. 24.

As is also shown in FIG. 24, the connector plates 127 are received through openings 156 formed in flanges 158 adjacent recesses 160 in the container 114. This further stabilizes the container 114 on the cart 112.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. For example, the frame 16, 116 and pedal 18, 118 could be used without the casters or any wheels.

What is claimed is:

1. An assembly for receiving a container comprising:
a frame for supporting a container;
a pedal connected to the frame;
an arm for opening a lid of the container; and
linkage connecting the arm to the pedal.

2. The assembly of claim 1 further including a plurality of wheels supporting the frame.

3. The assembly of claim 1 wherein the frame includes a base for supporting the container.

4. The assembly of claim 3 further including rear upright sections extending upward from the base.

5. The assembly of claim 4 further including a rear cross rail extending between the rear upright sections, the arm pivotably mounted to the rear cross rail.

6. The assembly of claim 5 wherein the arm is generally centered between the rear upright sections.

7. The assembly of claim 1 wherein the linkage includes a lower linkage extending rearward from the pedal and a vertical linkage, the vertical linkage connecting the lower linkage to the arm.

8. The assembly of claim 1 in combination with a container having a body portion and a lid hingeably connected to a rear wall of the body portion, wherein the arm extends over the lid.

9. The combination of claim 8 wherein the container is supported on the frame.

10. The combination of claim 9 wherein the frame includes a base for supporting the container and wherein the container is supported on the base.

11. The combination of claim 10 wherein the arm includes a rearward projection received in an opening at a front of the lid.

12. An assembly for receiving a container comprising:
a frame for receiving a container;
a pedal connected to the frame;
an arm for opening a lid of the container, the arm configured to extend over the lid of the container; and
linkage connecting the arm to the pedal, such that activating the pedal lifts the arm.

13. The assembly of claim 12 wherein the frame includes a base for supporting the container.

14. The assembly of claim 13 further including rear upright sections extending upward from the base.

15. The assembly of claim 12 wherein the arm is generally centered relative to the frame.

16. The assembly of claim 12 in combination with a container having a body portion and a lid hingeably connected to a rear wall of the body portion, wherein the arm extends over the lid.

17. The combination of claim 16 wherein the container is supported on the frame.

18. The combination of claim 17 wherein the frame includes a base for supporting the container and wherein the container is supported on the base.

19. The combination of claim 18 wherein the arm includes a rearward projection received in an opening at a front of the lid.
